(19) United States
(12) Patent Application Publication
(10) Pub. No.: US 2016/0259856 A1
(43) Pub. Date: Sep. 8, 2016

(54) CONSOLIDATING AND FORMATTING SEARCH RESULTS

(71) Applicant: International Business Machines Corporation, Armonk, NY (US)

(72) Inventors: Vijay Kumar Ananthapur Bache, Bangalore (IN); Madhusmita P. Patil, Hyderabad (IN)

(21) Appl. No.: 14/636,732

(22) Filed: Mar. 3, 2015

(51) Int. Cl. G06F 17/30

(52) U.S. Cl. CPC G06F 17/30867; G06F 17/30554; G06F 17/3053

(57) ABSTRACT

Embodiments of the present invention provide methods, computer program products, and systems for consolidating and formatting search results. Embodiments of the present invention can be used to consolidate, format, and return results to display only the relevant segments of aggregated results, which can reduce the likelihood of overlooking relevant sources of information, thereby improving the quality of search results returned to a user.

### BACKGROUND OF THE INVENTION

The present invention relates generally to the field of search engines, and more particularly to formatting and consolidating search results of search engines.

Search engines refer to information processing systems designed to search for data on information networks, such as the Internet. Search engines help users retrieve information available on countless sites. Typically, a user connects to a portal or other web site having a search engine where a user can enter a single query of a particular topic of interest. The search engine uses a web crawler that browses the Internet. The search engine analyzes the contents of each web page found by the web crawler and determines how it should be indexed. The index helps find relevant information on each web page found based on the user's search query. The usefulness of search engines typically depends on the relevance of the results they return to the user. Each search engine can be configured differently with different algorithms that help rank results to provide the most relevant results to the user first.

Search engines can use metadata to determine relevance to a user's search query. Such metadata can be used to describe the content and the context of a data files found on web pages. Content owners can “tag” data files with descriptors which can indicate the type of content that can be found on the web page. These meta-tags can allow search engines to discover relevant data.

### SUMMARY

Embodiments of the present invention provide methods, program products, and computer systems for consolidating and formatting search results. In one of embodiment of the present invention, a method is provided comprising the steps of: receiving a search query from an application; generating one or more search results having at least one meta-tag associated with a term of the search query; aggregating the generated search results based on media type, wherein the media type comprises one or more of audio, video, text, and pictures; determining whether to consolidate the aggregated search results; and if it is determined to consolidate the aggregated search results, consolidating the aggregated search results based, at least in part, on a preference of a user.

### BRIEF DESCRIPTION OF THE DRAWINGS

FIG. 1 is a functional block diagram illustrating a computing environment, in accordance with an embodiment of the present invention;

FIG. 2 is a flowchart illustrating operational steps for conducting a search, in accordance with an embodiment of the present invention;

FIG. 3 is a flowchart illustrating operational steps for generating aggregated search results, in accordance with an embodiment of the present invention;

FIG. 4 is a flowchart illustrating operational steps for consolidating aggregated search results, in accordance with an embodiment of the present invention; and

FIG. 5 is a block diagram of internal and external components of the computer systems of FIG. 1, in accordance with an embodiment of the present invention.

### DETAILED DESCRIPTION

Embodiments of the present invention recognize that search engines can return a plethora of information, including irrelevant and/or otherwise undesirable search results. In some instances, a search engine may return thousands of results, some of which may never be seen by a user. Thus, a user may overlook a source of information that may be useful simply because the information source is on the second or third page of the thousands returned by a search engine. Embodiments of the present invention provide solutions for formatting and consolidating search results that utilize meta-tagging to filter out portions of a result, such as portions not relevant to a user's search query. In this manner, as discussed in greater detail in this specification, embodiments of the present invention can be used to return results consolidated and formatted according to a user's search query and preferences. Accordingly, embodiments of the present invention can help consolidate the many results returned by a search engine into a set of results, reducing the likelihood of overlooking relevant sources of information.

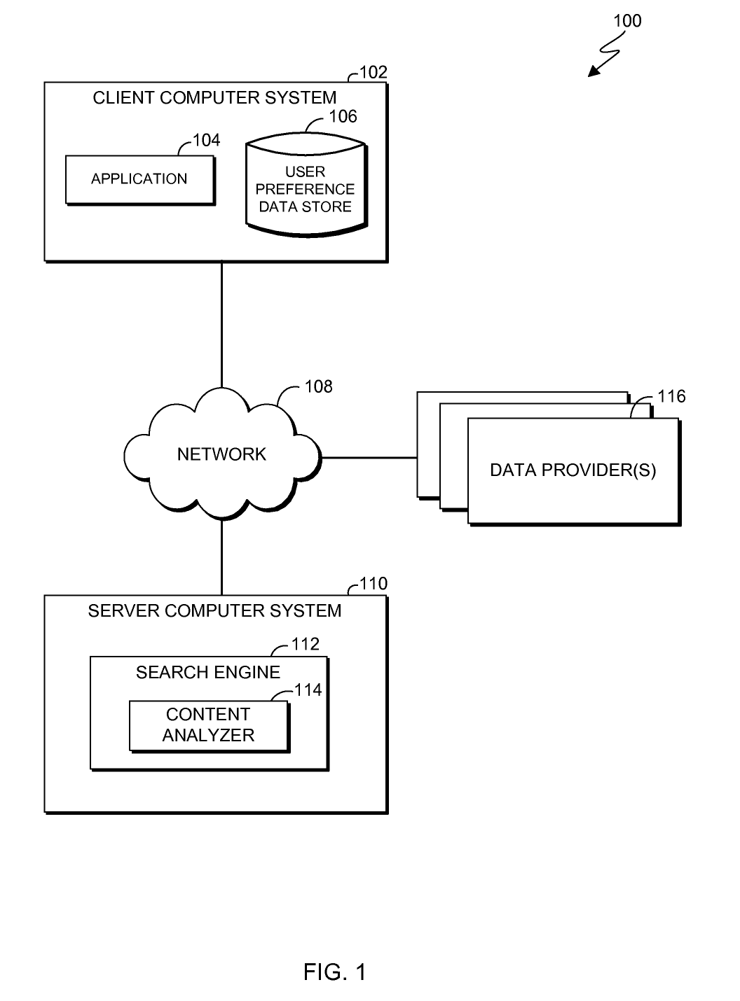

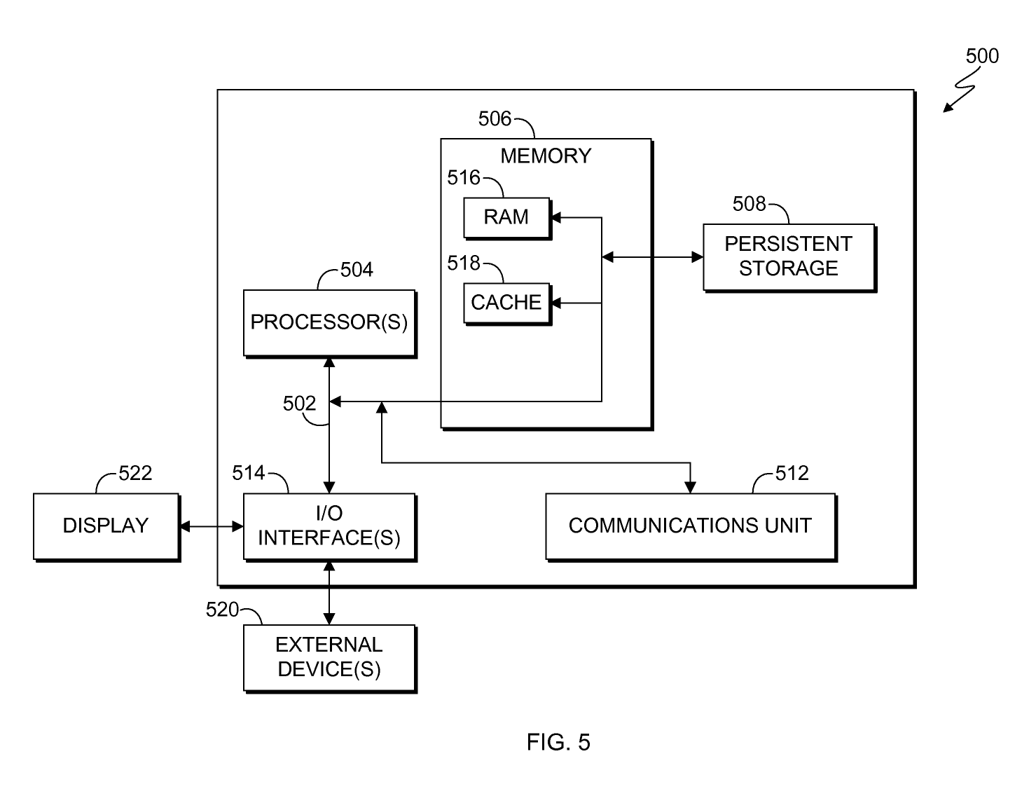

FIG. 1 is a functional block diagram illustrating a computing environment 100, in accordance with an embodiment of the present invention. Computing environment 100 includes client computer system 102, server computer system 110, and data providers 116, interconnected via network 108. Client computer system 102 and server computer system 110 can be desktop computers, laptop computers, specialized computer servers, or any other computer systems known in the art. In certain embodiments, client computer system 102 and server computer system 110 represent computer systems utilizing clustered computers and components to act as a single pool of seamless resources when accessed through network 108. In certain embodiments, client computer system 102 and server computer system 110 represent virtual machines. In general, client computer system 102 and server computer system 110 are representative of any electronic devices, or combination of electronic devices, capable of executing machine-readable program instructions, as described in greater detail with regard to FIG. 5.

Client computer system 102 includes application 104 and user preference data store 106. Application 104 enables client computer system 102 to access search engine 112. Application 104 communicates with server computer system 110 via network 108 (e.g., using TCP/IP) to enter one or more search queries comprising query terms (e.g., pertaining to a particular subject area that is of interest to a user). For example, application 104 can be implemented using a browser and web application that transmits search queries to, and receives results from, server computer system 110.

User preference data store 106 stores data from online activity. In general, user preference data store 106 can store data, such as browser history for a communications session (e.g., HTTP, HTTPS, FTP etc.) between application 104 and search engine 112 hosted on server computer system 110. For example, user preference data store 106 can store browsing activity, such as which websites a user frequents the most, the topics a user previously searched, which websites a user has previously visited, etc. User preference data store 106 can be implemented using any storage media known in the art. In other embodiments, user preference data store 106 can be hosted remotely.

Network 108 can be, for example, a local area network (LAN), a wide area network (WAN) such as the Internet, or a combination of the two, and include wired, wireless, or fiber optic connections. In general, network 108 can be any combination of connections and protocols that will support communications between client computer system 102, server computer system 110, and data providers 116, in accordance with a desired embodiment of the invention.

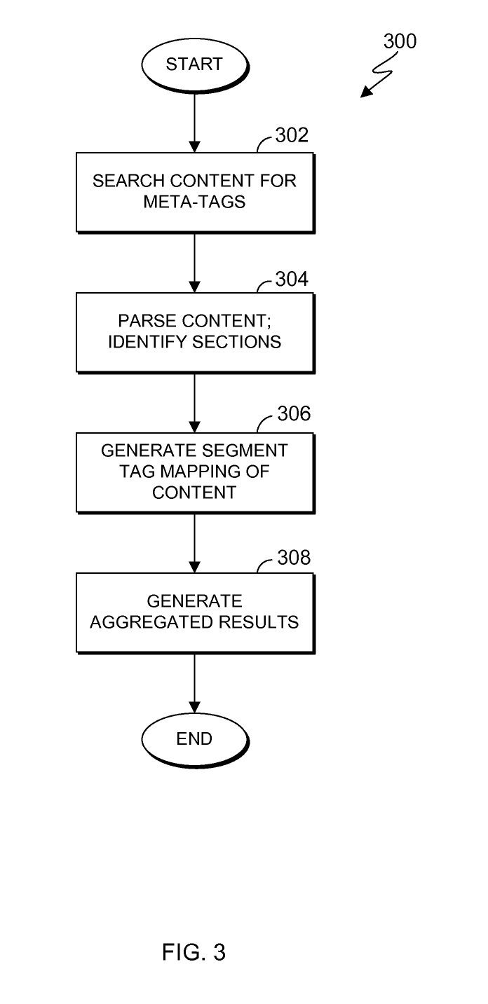

Server computer system 110 includes search engine 112. Search engine 112 is capable of executing a search query received from application 104 and returning results to application 104 via network 108. Search engine 112 includes content analyzer 114. Content analyzer 114 enables search engine 112 to search web pages for meta-tags of relevance to a search query, and to format and consolidate those results into a result set, as discussed in greater detail in FIG. 3. Search engine 112 is capable of executing a search query using content analyzer 114 during a search. For example, content analyzer 114 can tag content being searched on data providers 116 during an execution of a search query. In other embodiments, search engine 112 can transmit results to content analyzer 114 after search engine 112 conducts a search. For example, content analyzer 114 can receive content from search engine 112, analyze the content, and generate meta-tags for the content that content analyzer 114 received.

Data providers 116 represent one or more content sources that can be searched by search engine 112. For example, data providers 116 can be web pages, databases, etc. Content sources on data providers 116 can be associated with one or more meta-tags that identify different aspects of data. For example, meta-tags can be used to describe the content and the context of a data files found on web pages (e.g., user generated tags uploaded to a service, such as an image hosting service and/or other media sharing services). In one embodiment, data providers 116 include content that is already tagged. For example, where data providers 116 include services to which users can upload content (e.g., image hosting, media sharing, etc.), content can be tagged by a user. Content stored on data providers 116 can be stored on any storage media known in the art. For example, content on data providers 116 can be stored on a tape library, optical library, one or more independent hard disk drives, or multiple hard disk drives in a redundant array of independent disks (RAID). Similarly, data providers 116 can use any suitable storage architecture known in the art, such as relational databases, object-orientated databases, and/or one or more tables.

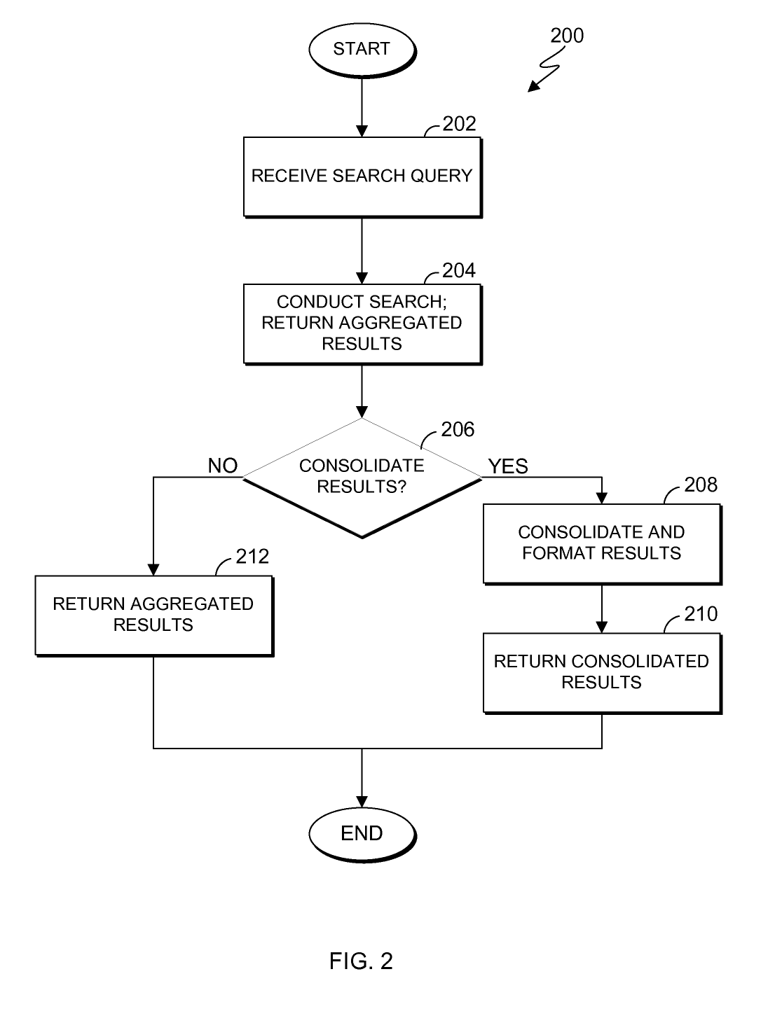

FIG. 2 is a flowchart 200 illustrating operational steps for generating consolidated search results, in accordance with an embodiment of the present invention.

In step 202, search engine 112 receives a search query from application 104. In other embodiments, search engine 112 can receive a search query from one or more other components of computing environment 100.

In step 204, search engine 112 conducts a search of data providers 116 for content associated with meta-tags that match terms of the search query and returns aggregated results to application 104. The phrase, “aggregated results”, as used herein, refers to compiled results comprising content having meta-tags that match one or more query terms of the search query.

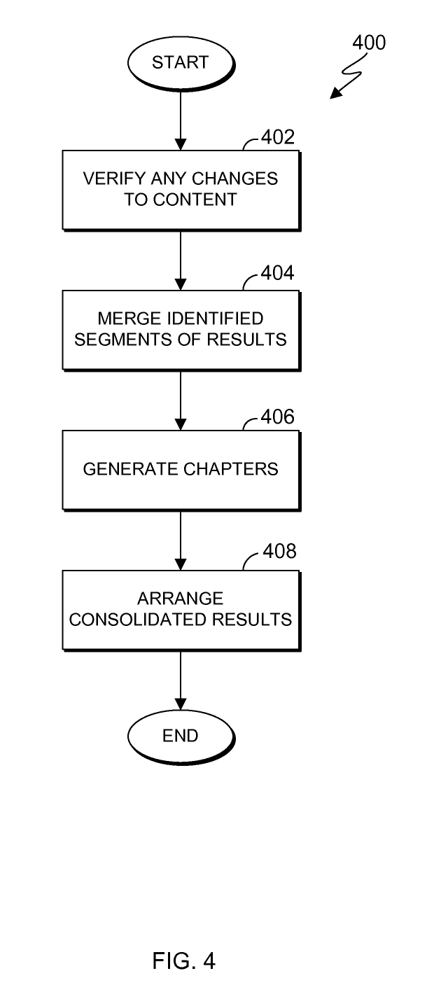

In step 206, search engine 112 determines whether to consolidate the aggregated results. In this embodiment, search engine 112 displays aggregated results to the user via application 104 and prompts the user to confirm whether to consolidate the aggregated results. If, in step 206, the user chooses to consolidate the results, then, in step 208, search engine 112 uses content analyzer 114 to consolidate the aggregated results. In this embodiment, content analyzer 114 consolidates the aggregated results so as to isolate and merge certain segments of content having meta-tags that match one or more query terms of the search query into a single, digestible document. In this embodiment, search engine 112 consolidates and formats the aggregated results based, at least in part, on user preference and media type (e.g., audio, video, text, and picture), as described in greater detail with regard to FIG. 4.

In this embodiment, search engine 112 displays a progress bar to the user of search engine 112 at application 104 to indicate the status of the consolidation process. Statuses can be displayed as a percentage of overall progress with regard to consolidation. For example, a status of 50% represents that consolidation of the results is halfway completed. In other embodiments, statuses can include, “not started”, “in-progress”, and “completed”.

In step 210, search engine 112 returns consolidated results of the search query to application 104. Search engine 112 then updates the progress bar to indicate that the consolidation process has finished at application 104.

If, in step 206, the user chooses not to consolidate the results, then, in step 212, search engine 112 returns the aggregated results to the user.

Accordingly, in this embodiment, a search is performed using meta-tags to identify content having meta-tags that match one or more query terms and is arranged in a manner for efficient user consumption. In some instances, content analyzer 114 can aggregate the identified content by media type. In other instances, content analyzer 114 can consolidate the aggregated results (i.e., isolate, merge, and display the merged segments of identified content by media type in a single document) based on user preference. Aggregating and consolidating aggregated results arranges information in a manner that can reduce the likelihood of overlooking relevant sources of information. Thus, this embodiment can improve the quality of results returned to a user.

FIG. 3 is a flowchart 300 illustrating operational steps for generating aggregated search results, in accordance with an embodiment of the present invention. For example, the operational steps of flowchart 300 can be performed at step 204 of flowchart 200.

In step 302, search engine 112 conducts a search on data providers 116 to obtain content that is associated with one or more meta-tags that match the search query. In this embodiment, search engine 112 calls content analyzer 114 to search content for meta-tags associated with the search query. For example, search engine 112 may receive a search query for “famous speeches”. Content analyzer 114 may then conduct a search for content whose meta-tags match the search query. If, for example, search engine 112 searches text content of a document on data providers 116, content analyzer 114 can search the document by recognizing meta-tags associated with the different sections of the document. If, for example, search engine 112 searches video content on data providers 116, content analyzer 114 can search the timeline of the video and recognize meta-tags associated with the corresponding unit of time of the video.

Optionally, content analyzer 114 can generate tags for content (e.g., documents, videos, photos, and/or other media) while conducting a search by searching keywords in content that match the query terms. For example, content analyzer 114 can search content, such as a document containing no meta-tags. Content analyzer 114 would then search the document for keywords in the document that matched the query terms. If, for example, content analyzer 114 identified keywords in the document that matched the query terms, content analyzer 114 can then generate a meta-tag for the identified keyword in that document that matched the query terms.

In this embodiment, a user can select whether search engine 112 uses content analyzer 114 during a search, or after search engine 112 conducts a search, to analyze content for meta-tags that match the search query. For example, search engine 112 can call content analyzer 114 to conduct a search for content having meta-tags that match the terms of the search query. If, for example, search engine 112 does not call content analyzer 114 to conduct a search for content having meta-tags that match the terms of the search query, search engine 112 can conduct a search for content and then pass the results of that search to content analyzer 114. Content analyzer 114 can then analyze the results received from search engine 112 to search for and identify meta-tags that match the search query.

In step 304, search engine 112 calls content analyzer 114 to parse identified content and identify sections (e.g., the rhetorical structure) of identified content. For example, in response to a search query for “causes of the great depression”, search engine 112 can return a document containing meta-tags for “the start of the great depression”, “causes of the great depression”, and “turning points of the great depression”. In step 304, content analyzer 114 can then identify that the document has three sections by using the meta-tags to classify and sort them as headers that split the document into three different sections.

In step 306, search engine 112 calls content analyzer 114 to generate a segment tag mapping of the searched content. The phrase, “segment-tag mapping”, as used herein, refers to a process wherein segments of media (e.g., text, video, picture, audio, etc.) having meta-tags that match the search query are identified. A “segment”, as used herein, refers to a particular portion of content having meta-tags that match the search query. A segment may vary depending on the type of content. For example, where the identified content is a document, a segment can be one or more paragraphs in that document. In another example, where the identified content is a video file, a segment can be a portion of the video (e.g., minute one to minute thirty of a five minute video). In yet another example, where the identified content is a web page, a segment can be a particular element on that web page.

In this embodiment, content analyzer 114 searches sections within each generated search result to identify segments of media having meta-tags that match one or more terms of the search query. For example, search engine 112 can return three different videos, video file A (five minutes long), video file B (three minutes long), and video file C (two minutes long), as aggregated results for an executed search for “famous speeches”. Content analyzer 114 can search the timeline of each of those videos to identify meta-tags that match one or more terms of the search query. Content analyzer 114 uses the meta-tags associated with a unit of time (e.g., the beginning of the speech at minute one) on the timeline of the video to identify segments of the video relevant to a user search query. For example, content analyzer 114 can identify that the first twenty seconds of video A are relevant to a user's search query, that minute one to one minute thirty of video B are relevant to a user's search query, and that minute one to one minute fifteen of video C are relevant to a user's search query. In other examples, content analyzer 114 can identify descriptions of a portion of video fixed to a certain point in the timeline of a video (e.g., “guitar solo” associated with minute two of video). In another example, content analyzer 114 can recognize descriptions of portions of video tied to a specific unit of time on a timeline of a video loaded to a media sharing service to identify meta-tags that match the search query.

In a similar manner, content analyzer 114 can search sections within each text-based result for meta-tags that match the query terms. For example, search engine 112 can return three different documents, document A (five paragraphs long), document B (three paragraphs long), and document C (two paragraphs long), as a result for an executed search for “famous speeches”. Content analyzer 114 can search the different sections (e.g., paragraphs) of each of those documents to identify meta-tags and map that meta-tag to the paragraph of text where the meta-tags were found. For example, content analyzer 114 can identify that the first two paragraphs of document A contain meta-tags that match a user's search query, that the third paragraph of document B contains meta-tags that match a user's search query, and that the first paragraph of document C contains meta-tags that match a user's search query.

In step 308, search engine 112 generates aggregated results. In this embodiment, search engine 112 calls content analyzer 114 to aggregate the identified content having meta-tags that match the query terms by media type. For example, in response to a search query on “famous speeches”, content analyzer 114 may return document 1, document 2, and video 1. Content analyzer 114 can then aggregate the results to generate aggregated results comprising a document section containing document 1, document 2, and a video section containing video 1.

Accordingly, in this embodiment, a search is performed using meta-tags, and returns aggregated results that display content having meta-tags that match the query terms and are arranged by media type. Returning results that display content having meta-tags that match the query terms helps improve the quality of search results, because meta-tags that match the query terms can be a reliable way of identifying relevant content.

FIG. 4 is a flowchart 400 illustrating operational steps for consolidating aggregated search results, in accordance with an embodiment of the present invention. For example, the operational steps of flowchart 400 can be performed at step 208 of flowchart 200.

In step 402, content analyzer 114 verifies any changes to the content identified used to generate the aggregated results generated in step 308. In this embodiment, content analyzer 114 searches data providers 116 for any new meta-tags that may have been added to the content that match the search query since the previously executed search. For example, content analyzer 114 can search data providers 116 and identify new meta-tags added to a document it previously identified as having meta-tags associated that matched the search query for “causes of the great depression”. Content analyzer 114 may then identify any new segments of text that match one or more terms of the search query. Content analyzer 114 can then prompt search engine 112 to update the progress bar.

In step 404, content analyzer 114 splices and merges the identified segments of the results. In this embodiment, content analyzer 114 splices the identified segments of the generated results having meta-tags associated with the search query based on media type according to lagrangian techniques. For example, search engine 112 can return three different videos, video file A (five minutes long), video file B (three minutes long), and video file C (two minutes long), as a result of an executed search for “famous speeches”. Content analyzer 114 then identifies that the first twenty seconds of video A are relevant to a user's search query, that minute one to one minute thirty of video B are relevant to a user's search query, and that minute one to one minute fifteen of video C are relevant to a user's search query.

In this embodiment, the identified content is organized using a quadtree approach. Content analyzer 114 prepares a neighbor list of every quadtree node. For example, the neighbor list can be populated using the neighbor naming method (NNM). Content analyzer 114 then merges videos A, B, and C by splicing the identified segments of A, B, and C (identified by the associated meta-tags of each respective video), and merging segments of videos A, B, and C to a new video, video D, comprising the relevant segments of videos A, B, and C (i.e., the first twenty seconds of video A, minute one to one minute thirty of video B, and minute one to one minute fifteen of video C). Content analyzer 114 then prompts search engine 112 to update the progress bar.

In another example, search engine 112 can return three different documents, document A (five paragraphs long), document B (three paragraphs long), and document C (two paragraphs long), as a result for an executed search for “famous speeches”. Content analyzer 114 can search the different sections (e.g., paragraphs) of each of those documents to identify meta-tags, and map that meta-tag to the paragraph of text where the meta-tags that match one or more terms of the search query were found. For example, content analyzer 114 can identify that the first two paragraphs of document A are relevant to a user's search query, that the third paragraph of document B are relevant to a user's search query, and that the first paragraph of document C are relevant to a user's search query. In step 404, content analyzer 114 can splice and merge the identified segments having meta-tags associated with the search query. For example, content analyzer 114 can then merge documents A, B, and C by splicing the identified segments of documents A, B, and C (identified by the associated meta-tags of each document), and merging segments of documents A, B, and C to a new document, document D, comprising the relevant segments of documents A, B, and C (i.e., the first two paragraphs of document A, the third paragraph of document B, and the first paragraph of document C).

In step 406, content analyzer 114 generates chapters to index the generated consolidated result set. In this embodiment, content analyzer 114 uses meta-tags associated with the consolidated media to generate an index. For example, where three segments of videos A, B, and C have been merged together to create video D, content analyzer 114 can generate an index of video D, to show that video D comprises three segments, video A from minute zero to minute one showing scene 1, video B from minute one to one minute thirty showing scene 2, and video C from one minute thirty to two minutes showing scene 3. Processing repeats until the different, consolidated media types (audio, video, text, and picture) have been indexed. Content analyzer 114 then prompts search engine 112 to update the progress bar.

In step 408, content analyzer 114 arranges the consolidated results for efficient user consumption. In this embodiment, content analyzer 114 uses data from user preference data store 106 to rank a consolidated result set based, at least in part, on user preferences. For example, content analyzer 114 can access user preference data store 106 and identify that the user accessed ten websites with the associated meta-tag “motivational” in the last week, five websites that have associated meta-tags of “fitness”, and three websites that have associated meta-tags of “politics”. If, for example, content analyzer 114 generated consolidated results for “famous speeches”, content analyzer 114 can rank and subsequently display results for “famous speeches” according to the number of times a user accessed a particular website. In this example, content analyzer 114 ranks and subsequently displays content with the following meta-tags from first to last respectively, “motivational”, “fitness”, and “politics” in the consolidated result set. In other embodiments, content analyzer 114 can use a user's browsing pattern to arrange the consolidated results based on the source. Content analyzer 114 then prompts search engine 112 to update the progress bar to display 100%, indicating that the consolidation process has finished. In other embodiments, search engine 112 can arrange the consolidated results based on the source according to its own algorithms. For example, the consolidated results can be filtered to display a set number of results (e.g., only the top ten sources of content).

Accordingly, in this embodiment, results are consolidated, formatted, and returned to display only the relevant segments of the aggregated results. Again, consolidating aggregated results arranges information in a manner that can reduce the likelihood of overlooking relevant sources of information. Thus, this embodiment helps to improve the quality of search results returned to a user by isolating and only displaying relevant segments of content.

FIG. 5 is a block diagram of internal and external components of a computer system 500, which is representative the computer systems of FIG. 1, in accordance with an embodiment of the present invention. It should be appreciated that FIG. 5 provides only an illustration of one implementation and does not imply any limitations with regard to the environments in which different embodiments may be implemented. In general, the components illustrated in FIG. 5 are representative of any electronic device capable of executing machine-readable program instructions. Examples of computer systems, environments, and/or configurations that may be represented by the components illustrated in FIG. 5 include, but are not limited to, personal computer systems, server computer systems, thin clients, thick clients, laptop computer systems, tablet computer systems, cellular telephones (e.g., smart phones), multiprocessor systems, microprocessor-based systems, network PCs, minicomputer systems, mainframe computer systems, and distributed cloud computing environments that include any of the above systems or devices.

Computer system 500 includes communications fabric 502, which provides for communications between one or more processors 504, memory 506, persistent storage 508, communications unit 512, and one or more input/output (I/O) interfaces 514. Communications fabric 502 can be implemented with any architecture designed for passing data and/or control information between processors (such as microprocessors, communications and network processors, etc.), system memory, peripheral devices, and any other hardware components within a system. For example, communications fabric 502 can be implemented with one or more buses.

Memory 506 and persistent storage 508 are computer-readable storage media. In this embodiment, memory 506 includes random access memory (RAM) 516 and cache memory 518. In general, memory 506 can include any suitable volatile or non-volatile computer-readable storage media. Software is stored in persistent storage 508 for execution and/or access by one or more of the respective processors 504 via one or more memories of memory 506.

Persistent storage 508 may include, for example, a plurality of magnetic hard disk drives. Alternatively, or in addition to magnetic hard disk drives, persistent storage 508 can include one or more solid state hard drives, semiconductor storage devices, read-only memories (ROM), erasable programmable read-only memories (EPROM), flash memories, or any other computer-readable storage media that is capable of storing program instructions or digital information.

The media used by persistent storage 508 can also be removable. For example, a removable hard drive can be used for persistent storage 508. Other examples include optical and magnetic disks, thumb drives, and smart cards that are inserted into a drive for transfer onto another computer-readable storage medium that is also part of persistent storage 508.

Communications unit 512 provides for communications with other computer systems or devices via a network (e.g., network 108). In this exemplary embodiment, communications unit 512 includes network adapters or interfaces such as a TCP/IP adapter cards, wireless Wi-Fi interface cards, or 3G or 4G wireless interface cards or other wired or wireless communication links. The network can comprise, for example, copper wires, optical fibers, wireless transmission, routers, firewalls, switches, gateway computers and/or edge servers. Software and data used to practice embodiments of the present invention can be downloaded to client computer system 102 through communications unit 512 (e.g., via the Internet, a local area network or other wide area network). From communications unit 512, the software and data can be loaded onto persistent storage 508.

One or more I/O interfaces 514 allow for input and output of data with other devices that may be connected to computer system 500. For example, I/O interface 514 can provide a connection to one or more external devices 520 such as a keyboard, computer mouse, touch screen, virtual keyboard, touch pad, pointing device, or other human interface devices. External devices 520 can also include portable computer-readable storage media such as, for example, thumb drives, portable optical or magnetic disks, and memory cards. I/O interface 514 also connects to display 522.

Display 522 provides a mechanism to display data to a user and can be, for example, a computer monitor. Display 522 can also be an incorporated display and may function as a touch screen, such as a built-in display of a tablet computer.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A method for consolidating and formatting search results, the method comprising the steps of:
receiving, by one or more computer processors, a search query from an application;
generating, by one or more computer processors, one or more search results having at least one meta-tag associated with a term of the search query;
aggregating, by one or more computer processors, the generated search results based on media type, wherein the media type comprises one or more of audio, video, text, and pictures;
determining, by one or more computer processors, whether to consolidate the aggregated search results; and
if it is determined to consolidate the aggregated search results, consolidating, by one or more computer processors, the aggregated search results based, at least in part, on a preference of a user.

2. The method of claim 1, further comprising the steps of:
generating, by one or more computer processors, the at least one meta-tag during execution of the search query.

3. The method of claim 1, wherein generating search results having at least one meta-tag associated with a term of the search query comprises the steps of:
conducting, by one or more computer processors, a search based on the search query; and
identifying, by one or more computer processors, content having the at least one meta-tag associated with a term of the search query.

4. The method of claim 1, further comprising the steps of:
identifying, by one or more computer processors, segments of content having associated meta-tags that match a term of the search query; and
generating, by one or more computer processors, a map of the identified segments of content and associated meta-tags.

5. The method of claim 1, wherein determining whether to consolidate the aggregated search results comprises the steps of:
displaying, by one or more computer processors, the aggregated search results to the user; and
prompting, by one or more computer processors, the user to confirm consolidation of the aggregated search results.

6. The method of claim 4, wherein consolidating the aggregated search results based, at least in part, on the preference of the user comprises the steps of:
splicing, by one or more computer processors, the identified segments of content;
merging, by one or more computer processors, the identified segments of content to generate consolidated search results according to media type; and
formatting, by one or more computer processors, the consolidated search results, based, at least in part, on the preference of the user.

7. The method of claim 6, wherein formatting the consolidated search results, based, at least in part, on the preference of the user comprises the steps of:
accessing, by one or more computer processors, a browsing history of the user to sort the consolidated search results;
ranking, by one or more computer processors, the consolidated search results according to the browsing history of the user; and
generating, by one or more computer processors, chapters to index the consolidated search results.

8. A computer program product for consolidating and formatting search results comprising:
one or more computer readable storage media and program instructions stored on the one or more computer readable storage media, the program instructions comprising:
program instructions to receive a search query from an application;
program instructions to generate one or more search results having at least one meta-tag associated with a term of the search query;
program instructions to aggregate the generated search results based on media type, wherein the media type comprises one or more of audio, video, text, and pictures;
program instructions to determine whether to consolidate the aggregated search results; and
if it is determined to consolidate the aggregated search results, program instructions to consolidate the aggregated search results based, at least in part, on a preference of a user.

9. The computer program product of claim 8, further comprising:
program instructions to generate the at least one meta-tag during execution of the search query.

10. The computer program product of claim 8, wherein the program instructions to generate search results having at least one meta-tag associated with a term of the search query comprise:
program instructions to conduct a search based on the search query; and
program instructions to identify content having the at least one meta-tag associated with a term of the search query.

11. The computer program product of claim 8, further comprising:
program instructions to identify segments of content having associated meta-tags that match a term of the search query; and
program instructions to generate a map of the identified segments of content and associated meta-tags.

12. The computer program product of claim 9, wherein the program instructions to determine whether to consolidate the aggregated search results comprise:
program instructions to display the aggregated search results to the user; and
program instructions to prompt the user to confirm consolidation of the aggregated search results.

13. The computer program product of claim 11, wherein the program instructions to consolidate the aggregated search results based, at least in part, on the preference of the user comprise:
program instructions to splice the identified segments of content;
program instructions to merge the identified segments of content to generate consolidated search results according to media type; and
program instructions to format the consolidated search results, based, at least in part, on the preference of the user.

14. The computer program product of claim 13, wherein the program instructions to format the consolidated search results, based, at least in part, on the preference of the user comprise:
program instructions to access a browsing history of the user to sort the consolidated search results;
program instructions to rank the consolidated search results according to the browsing history of the user; and
program instructions to generate chapters to index the consolidated search results.

15. A computer system consolidating and formatting search results comprising:
one or more computer processors;
one or more computer readable storage media; and
program instructions stored on the one or more computer readable storage media for execution by at least one of the one or more processors, the program instructions comprising:
program instructions to receive a search query from an application;
program instructions to generate one or more search results having at least one meta-tag associated with a term of the search query;
program instructions to aggregate the generated search results based on media type, wherein the media type comprises one or more of audio, video, text, and pictures;
program instructions to determine whether to consolidate the aggregated search results; and
if it is determined to consolidate the aggregated search results, program instructions to consolidate the aggregated search results based, at least in part, on a preference of a user.

16. The computer system of claim 15, wherein the program instructions to generate search results having at least one meta-tag associated with a term of the search query comprise:
program instructions to conduct a search based on the search query; and
program instructions to identify content having the at least one meta-tag associated with a term of the search query.

17. The computer system of claim 15, further comprising:
program instructions to identify segments of content having associated meta-tags that match a term of the search query; and
program instructions to generate a map of the identified segments of content and associated meta-tags.

18. The computer system of claim 15, wherein the program instructions to determine whether to consolidate the aggregated search results comprise:
program instructions to display the aggregated search results to the user; and
program instructions to prompt the user to confirm consolidation of the aggregated search results.

19. The computer system of claim 17, wherein the program instructions to consolidate the aggregated search results based, at least in part, on the preference of the user comprise:
program instructions to splice the identified segments of content;
program instructions to merge the identified segments of content to generate consolidated search results according to media type; and
program instructions to format the consolidated search results, based, at least in part, on the preference of the user.

20. The computer system of claim 19, wherein the program instructions to format the consolidated search results, based, at least in part, on the preference of the user comprise:
program instructions to access a browsing history of the user to sort the consolidated search results;
program instructions to rank the consolidated search results according to the browsing history of the user; and
program instructions to generate chapters to index the consolidated search results.
